(19) United States
(12) Patent Application Publication
(10) Pub. No.: US 2019/0000047 A1
(43) Pub. Date: Jan. 3, 2019

(54) BEEHIVE WAX CAPPING SEPARATOR

(71) Applicant: Blue Heron Gardens Ltd., Cudworth (CA)

(72) Inventor: Jeff Shirley, Cudworth (CA)

(21) Appl. No.: 16/021,820

(22) Filed: Jun. 28, 2018

Related U.S. Application Data
(60) Provisional application No. 62/526,143, filed on Jun. 28, 2017.

(51) Int. Cl. A01K 59/02

(52) U.S. Cl. CPC A01K 59/02

(57) ABSTRACT

Beehive wax capping separators for separating wax cappings from residual honey contained therein are provided. These separators are configured to fit into conventional Langstroth frame extractors.

### CROSS-REFERENCE

This application claims the benefit of U.S. Provisional Patent Application No. 62/526,143, filed on Jun. 28, 2017, the contents of which are fully incorporated herein by reference.

### FIELD OF THE INVENTION

The present invention relates to beehive wax capping separators for separating wax cappings from residual honey contained therein, and more specifically to separators that are configured to fit into conventional Langstroth frame extractors.

### BACKGROUND OF THE INVENTION

During honey production, empty Langstroth frames are deployed in honey supers to allow bees to make honey and store it on the frames. The frames end up containing honeycomb made by the bees, which once filled with honey are then capped with wax by the bees to cure and hold it.

Beekeepers typically harvest honey by pulling the honey filled frames out of the supers, then decapping them. This involves removing the thin layer of wax cappings on the honeycomb using either a scratching device or a heated cutting device. Decapping creates a byproduct typically called wax cappings, which is a mixture of wax and honey.

The decapped frames are then loaded into a conventional radial or horizontal honey extractor that is configured for accepting standard Langstroth frames. A variety of types and models of extractors exist that support Langstroth frames. These extractors typically spin the frames and apply centrifugal force to have the honey spin out of the decapped honeycomb and into a storage tank. It is common that some additional wax cappings that are still attached to the honeycomb or the frame also falls into the storage tank with the honey.

As the honey in a storage tank settles, wax tends to float to the top. Typically this wax, referred to also as “wax cappings”, is removed from the honey product and further processed as it is still saturated with honey.

The removed wax cappings, taken from both the decapping stage and removed from the top of the storage tanks, contain a significant amount of honey mixed with the wax. It is desirable that this honey be separated from the wax cappings to increase overall honey yields.

Current honey-wax separation processes use augers and work on large scale quantities. Heterogenous mixtures of wax cappings and honey are typically augered off into large containers, and then processed in washing or melting bins. Large sized beekeepers typically have large containers which hold bulk wax cappings, and a very large separator can be used with those containers to extract honey from the wax before melting it. This process is very expensive and not cost feasible for smaller producers, such as those that have under 300 hives.

Small to medium sized beekeepers either wash or melt the wax cappings, with the extra honey still in it. This honey becomes waste honey or a degraded in quality honey product if harvested through melting tanks. This means that there is ultimately lost honey product in the extraction process. Furthermore, the processing of wax cappings increases wax processing time due to the extra honey needing to be separated from the wax.

What is needed, therefore, are honey-wax separators, used for extracting the honey from wax cappings, that increase overall honey yields and are convenient for use by small to medium sized beekeepers.

### SUMMARY OF THE INVENTION

The present invention therefore seeks to provide means that allow for separating honey from wax cappings while utilizing conventional honey extractors.

According to a broad aspect of the present invention, there is provided a wax capping separator for separating honey from wax cappings, the separator comprising:
a receptacle configured to fit into a conventional extractor for standard Langstroth frames;
wherein the receptacle comprises at least one aperture allowing the honey to exit the receptacle while wax material from the wax capping remains inside the receptacle.

Preferably, the honey exits the receptacle through the at least one aperture during operation of the conventional honey extractor.

A detailed description of exemplary embodiments of the present invention is given in the following. It is to be understood, however, that the invention is not to be construed as being limited to these embodiments. The exemplary embodiments are directed to a particular application of the present invention, while it will be clear to those skilled in the art that the present invention has applicability beyond the exemplary embodiments set forth herein.

### BRIEF DESCRIPTION OF THE DRAWINGS

In the accompanying drawings, which illustrate exemplary embodiments of the present invention:

FIG. 1 is a perspective view of a first embodiment of the present invention;

FIG. 2a is a perspective view of a second embodiment of the present invention with one of the mesh walls in a closed position;

FIG. 2b is a perspective view of a second embodiment of the present invention with one of the mesh walls in a closed position;

FIG. 2c is a perspective view of a second embodiment of the present invention with one of the mesh walls in a closed position;

FIG. 2d is a perspective view of a second embodiment of the present invention with one of the mesh walls in a closed position;

FIG. 2e is a perspective view of a second embodiment of the present invention with one of the mesh walls in an open position; and

FIG. 2f is a perspective view of a second embodiment of the present invention with one of the mesh walls in an open position.

Exemplary embodiments of the present invention will now be described with reference to the accompanying drawings.

### DETAILED DESCRIPTION OF EXEMPLARY EMBODIMENTS

Throughout the following description, specific details are set forth in order to provide a more thorough understanding to persons skilled in the art. However, well-known elements may not have been shown or described in detail to avoid unnecessarily obscuring the disclosure. The following description of examples of the technology is not intended to be exhaustive or to limit the invention to the precise form of any exemplary embodiment. Accordingly, the description and drawings are to be regarded in an illustrative, rather than a restrictive, sense.

The present invention is directed to wax capping separators for separating honey from wax cappings. The separators comprises a receptacle configured to fit into existing conventional extractors for standard Langstroth frames. Preferably, the receptacle fits into and engages with the system that mounts Langstroth frames in the extractor. The receptacle comprises at least one aperture that allows honey to exit the receptacle while the wax material from the wax cappings remains inside the receptacle. Preferably, the honey exits the receptacle during operation of the conventional honey extractor.

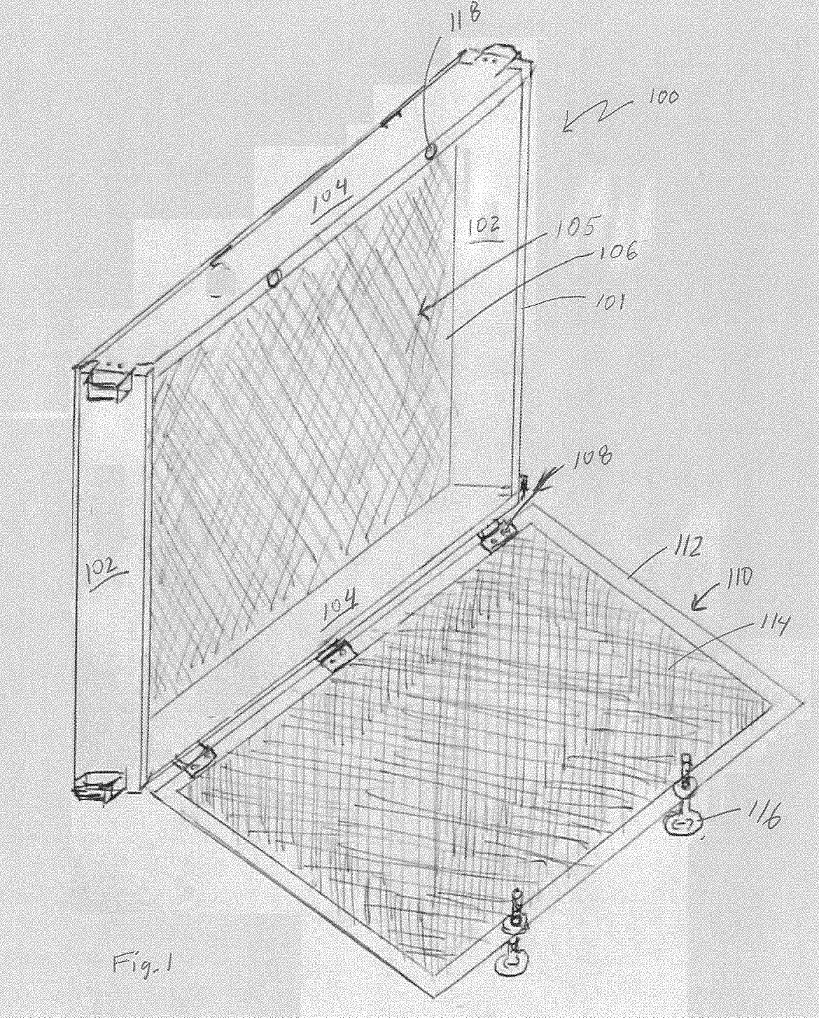

Turning to FIG. 1, a first embodiment of the present invention is illustrated. A rectangular receptacle 100 is shown, comprising a support frame 101 and two mesh walls 105, 110 enclosing the frame 101.

Two first frame members 102 and two second frame members 104 are assembled to form the rectangular frame 101 shown. Preferably, the frame is made of wood, however it may be made of other suitable materials that would be known to a person skilled in the art. As the rectangular receptacle 100 is about the same size as a Langstroth frame, the first frame members 102 members shown preferably have dimensions of 9¼″×1⅜″×⅝″, while the second frame members 104 shown preferably have dimensions 19″×1″×⅝″.

The two mesh walls 105, 110 each comprise a wall frame (only 112 shown) which supports a mesh sheet 106, 114. As the rectangular receptacle 100 is about the same size as a Langstroth frame, the mesh walls 105, 110 shown preferably have dimensions of 19″×9″. The mesh sheets 106, 114 are made of a material that allows honey to flow outside the receptacle 100 while wax material from the wax cappings are kept inside the receptacle 100. Preferably, the mesh sheets 106, 114 comprise a stainless steel mesh material, however it may be made of other suitable materials that would be known to a person skilled in the art. For example, the mesh sheets may be made of a stainless steel material of SS 304 #8 0.028×0.097 specification.

One of the mesh walls 105 is mounted onto the support frame 101 by fastening its wall frame to the support frame 101 by using screws or any other means known to a person skilled in the art.

The other mesh wall 110 is mounted to the support frame 101 by hinging members 108 allowing the mesh wall 110 to be in a closed or open position while mounted on the support frame 101. While in a closed positioned, the mesh wall 110 can further be reversibly fastened to the support frame 101. This may occur by using thumb screws 116, having a threaded surface, that pass through outlets in the wall frame 112 and engage with threaded apertures 118 in the support frame 101 allowing the mesh wall 110 to be fastened to the support frame 101 while in a closed position.

In operation, wax capping are placed into the receptacle 100. The mesh wall 110 is closed and fastened by the thumb screw members 116. The receptacle 100 is mounted into a conventional honey extractor used for Langstroth frames. As the extractor is operated honey exits the receptacle 100 through the apertures in the mesh walls 105, 110 and into a storage tank, while the wax material of the wax cappings remain inside the receptacle 100. In some embodiments, a radial honey extractor is used to apply a centrifugal force to the receptacle 100 facilitating the exit of honey from it.

The resulting material in the receptacle 100 is a much dryer wax, wherein most of the honey in the storage tank has been separated without heat treating or melting. This honey is therefore of higher value than so called “melter honey”, a poor quality honey by-product from melting wax cappings with honey contained inside for the purpose of separating the two products.

The wax material left in the receptacle 100 after the extraction cycle contains much less honey in it than in traditional cappings. It may be removed from the receptacle 100 using a hive tool or other scraping device.

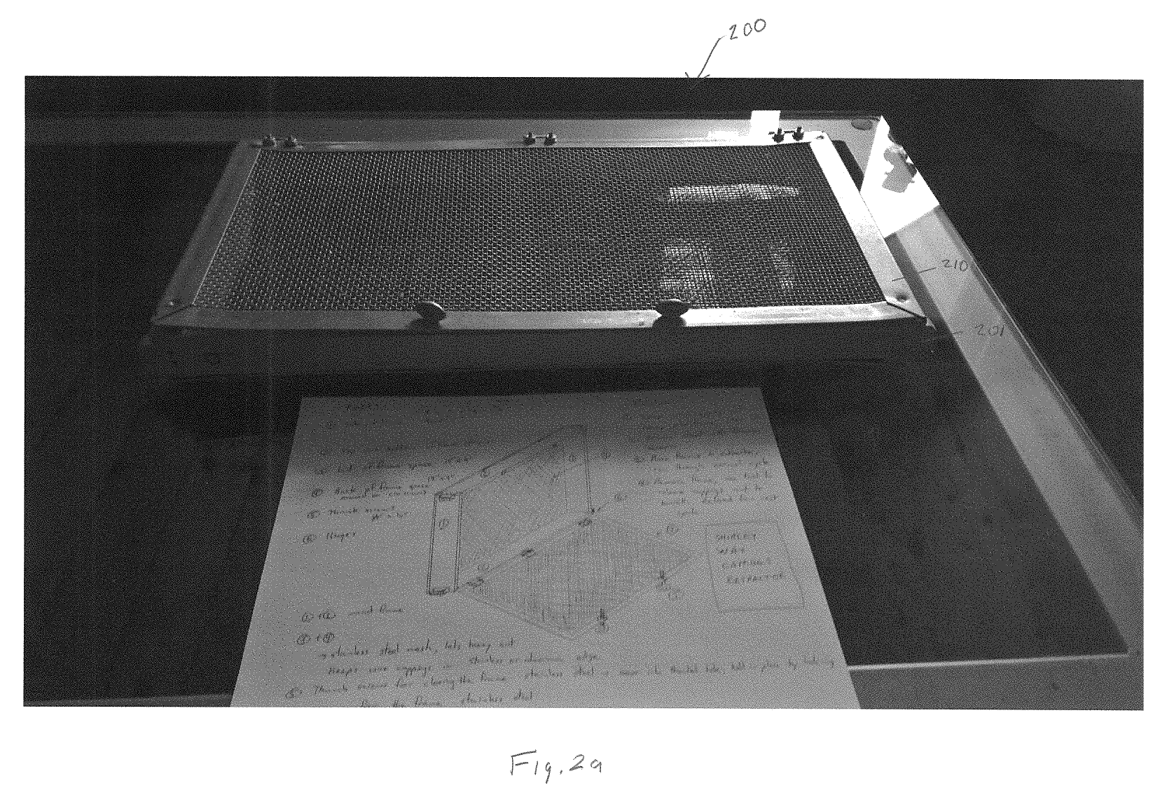

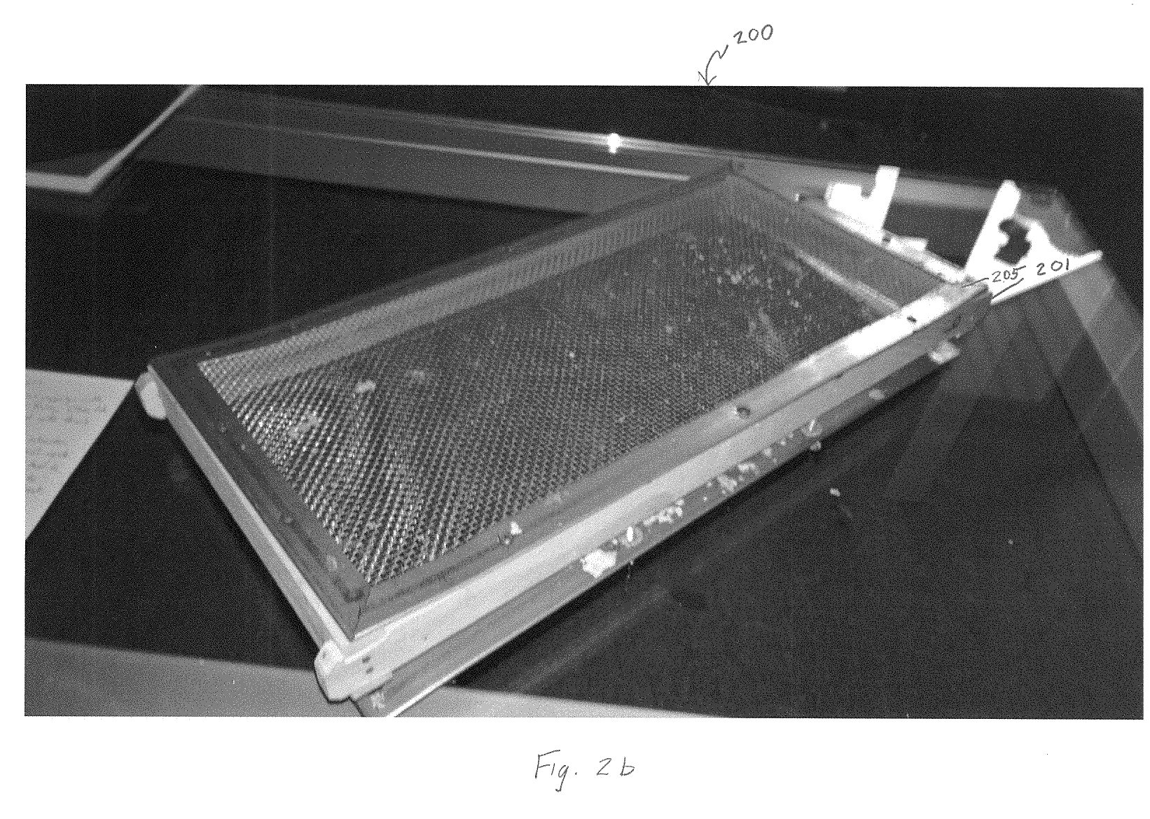

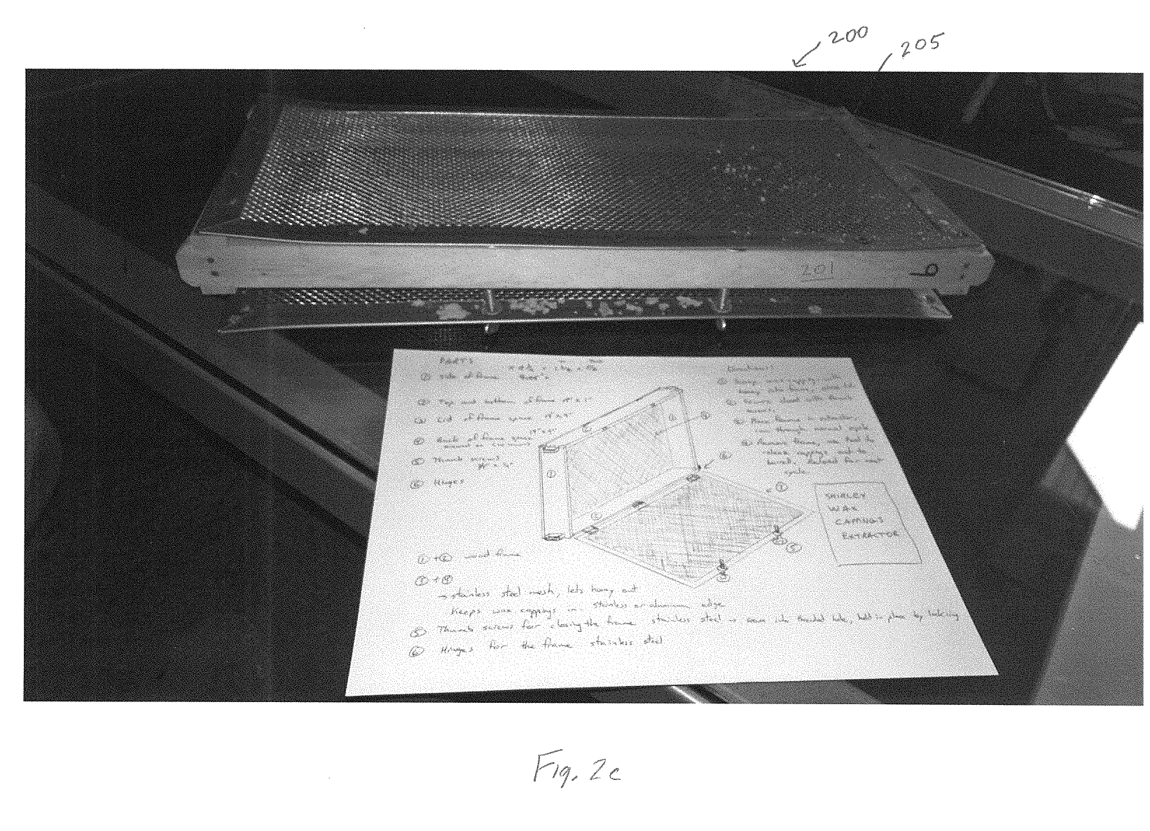

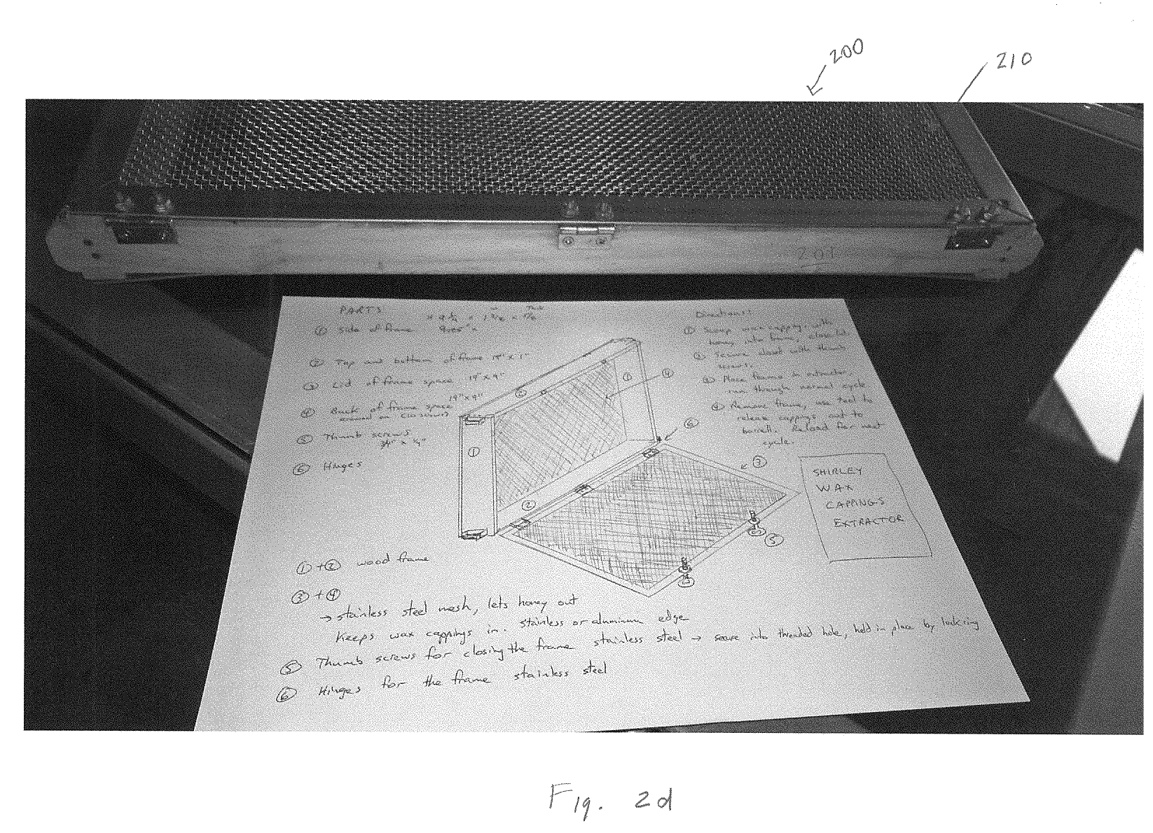

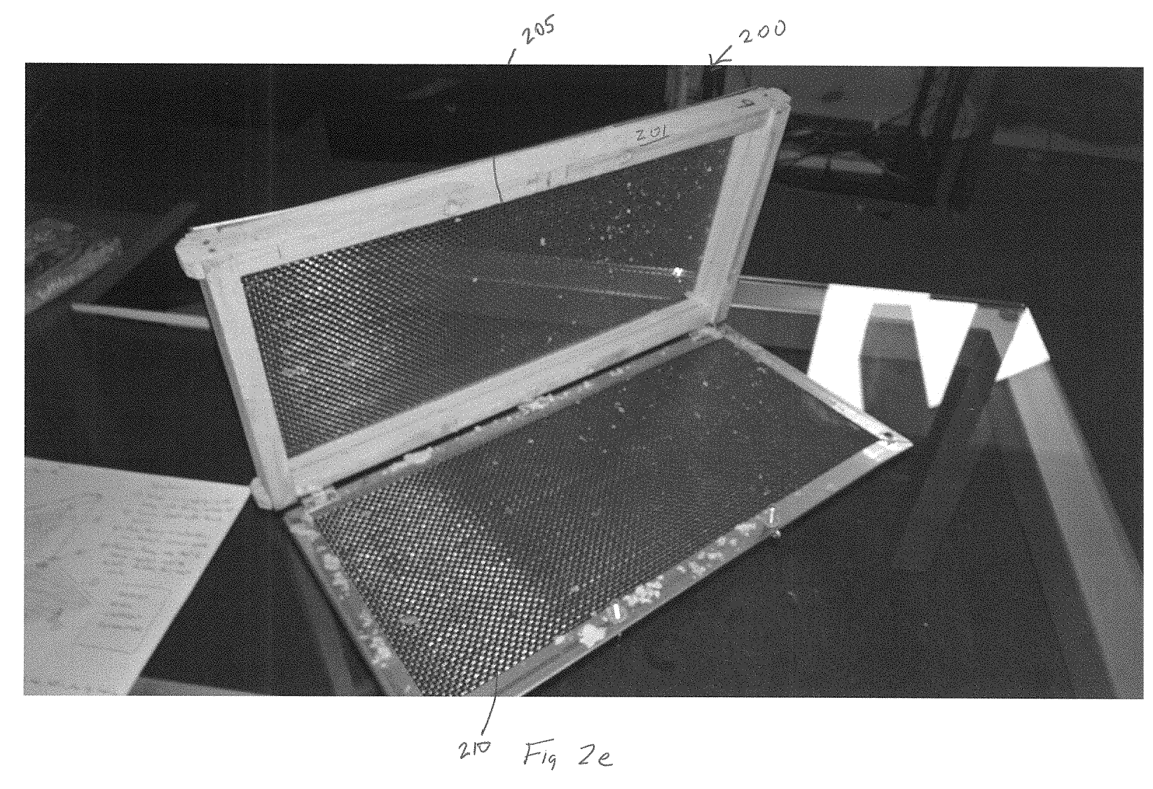

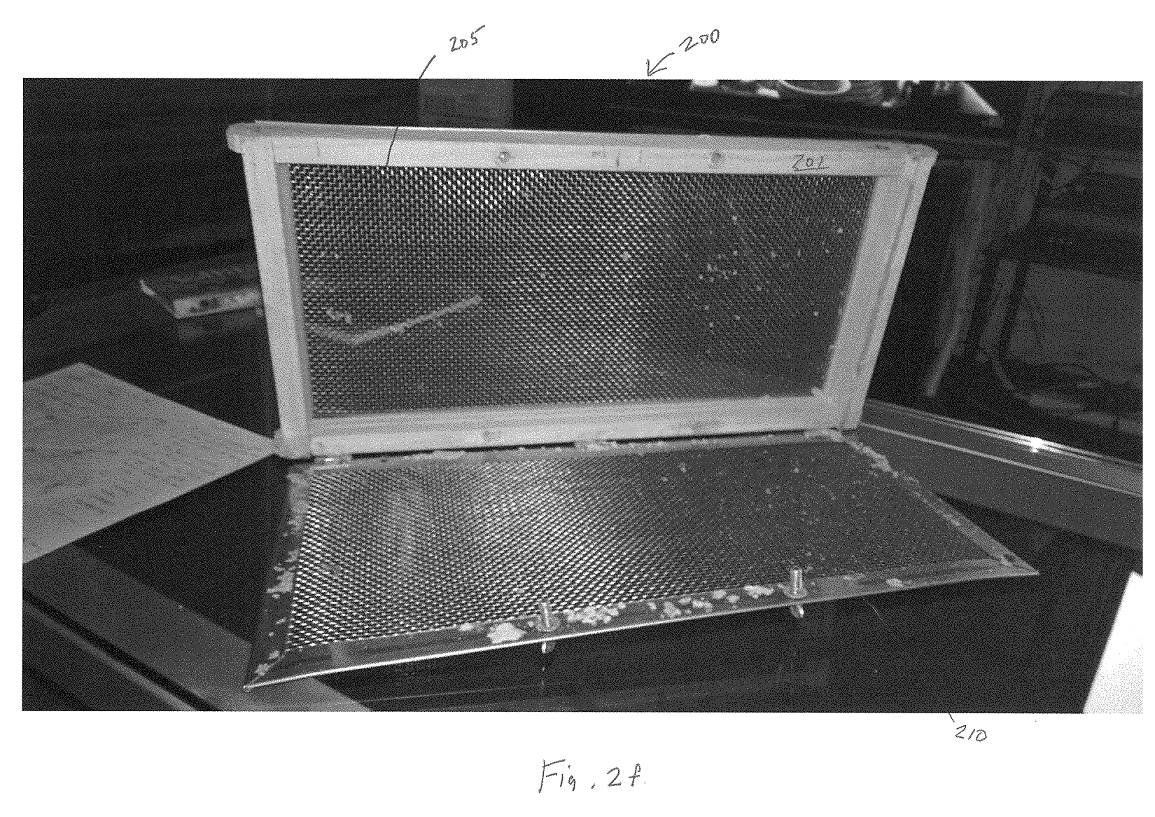

Turning to FIGS. 2a to 2f, a second embodiment of the present invention is illustrated, which is similar to the first embodiment described above. A rectangular receptacle 200 is shown, comprising a support frame 201 and two mesh walls 205, 210 enclosing the frame 201. FIGS. 2a to 2d illustrate the mesh wall 210 of the second embodiment in a closed position, FIGS. 2e and 2f illustrate the mesh wall 210 of the second embodiment in an open position.

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”.
“connected”, “coupled”, or any variant thereof, means any connection or coupling, either direct or indirect, between two or more elements; the coupling or connection between the elements can be physical, logical, or a combination thereof.
“herein”, “above”, “below”, and words of similar import, when used to describe this specification shall refer to this specification as a whole and not to any particular portions of this specification.
“or”, in reference to a list of two or more items, covers all of the following interpretations of the word: any of the items in the list, all of the items in the list, and any combination of the items in the list.
the singular forms “a”, “an” and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

Where a component (e.g. a circuit, module, assembly, device, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of methods and apparatus have been described herein for purposes of illustration. These are only examples. The technology provided herein can be applied to contexts other than the exemplary contexts described above. Many alterations, modifications, additions, omissions and permutations are possible within the practice of this invention. This invention includes variations on described embodiments that would be apparent to the skilled person, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

The foregoing is considered as illustrative only of the principles of the invention. The scope of the claims should not be limited by the exemplary embodiments set forth in the foregoing, but should be given the broadest interpretation consistent with the specification as a whole.

1. A wax capping separator for separating honey from wax cappings, the separator comprising:
a receptacle configured to fit into a conventional extractor for standard Langstroth frames;
wherein the receptacle comprises at least one aperture allowing the honey to exit the receptacle while wax material from the wax capping remains inside the receptacle.
